(19) United States
(12) Patent Application Publication
(10) Pub. No.: US 2024/0212908 A1
(43) Pub. Date: Jun. 27, 2024

(54) THROUGH-MAGNETIC INDUCTOR

(71) Applicants: Advanced Micro Devices, Inc., Santa Clara, CA (US); ATI Technologies ULC, Markham (CA)

(72) Inventors: Robert Grant Spurney, Austin, TX (US); Alexander Helmut Pfeiffenberger, Markham (CA); Sri Ranga Sai Boyapati, Austin, TX (US); Deepak Vasant Kulkarni, Austin, TX (US)

(73) Assignees: Advanced Micro Devices, Inc., Santa Clara, CA (US); ATI Technologies ULC, Markham (CA)

(21) Appl. No.: 18/478,416

(22) Filed: Sep. 29, 2023

Related U.S. Application Data
(60) Provisional application No. 63/434,456, filed on Dec. 21, 2022.

(51) Int. Cl. H01F 17/00; H01F 17/04; H01F 27/255

(52) U.S. Cl. CPC H01F 17/0013; H01F 17/04; H01F 27/255; H01F 2017/002; H01F 2017/048

(57) ABSTRACT

The disclosed inductor includes a magnetic material surrounding a conductive core. The magnetic material and conductive core can be embedded in a substrate. The magnetic material and conductive core can be formed in the substrate, using a magnetic composite material. Various other systems and methods are also disclosed.

### CROSS REFERENCE TO RELATED APPLICATION

This application claims the benefit of U.S. Provisional Application No. 63/434,456, filed 21 Dec. 2022, the disclosure of which is incorporated, in its entirety, by this reference.

### BACKGROUND

Inductors are common components for various circuits that can store energy when a current flows through it such that when there is a change in current, the inductor can release stored energy to act as a balance. An air-core inductor (ACI) is made of a conductive coil without a core (e.g., having air as its core). ACIs are commonly used in solutions at a package level of a circuit device, such as in an integrated voltage regulator (IVR) in part, because ACIs can be integrated into a substrate using substrate processes. However, the inductive performance of ACIs can be limited.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a diagram of an exemplary through-magnetic or through-ferrite plated through-hole (PTH) inductor.

FIG. 2 is a diagram of another exemplary through-magnetic inductor.

FIGS. 3A-B are diagrams of additional exemplary through-magnetic inductors.

FIG. 4 is a diagram of an exemplary voltage regulator having a through-magnetic inductor.

FIGS. 5A-H are diagrams of exemplary stages for fabricating a through-magnetic inductor.

FIGS. 6A-I are diagrams of additional exemplary stages for fabricating a through-magnetic inductor.

FIG. 7A-H are diagrams of additional exemplary stages for fabricating a through-magnetic inductor.

FIG. 8 is a flow diagram of an exemplary method for fabricating a through-magnetic inductor.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a through-magnetic inductor that can be fabricated with standard substrate processes. As will be explained in greater detail below, implementations of the present disclosure provide an inductor having a magnetic material surrounding a conductive core that can be embedded in a substrate. The magnetic material can provide improved inductive performance over an ACI. In addition, the through-magnetic PTH inductor described herein can be fabricated without requiring significant changes to a standard fabrication system.

In one implementation, an inductor, which in some examples can be part of an integrated voltage regulator (e.g., with a through-magnetic inductor), includes a substrate, a magnetic material at least partially embedded in the substrate, and a conductive core extending at least partially through the magnetic material such that the magnetic material at least partially surrounds the conductive core.

In some examples, the magnetic material comprises a magnetic composite material. In some examples, the magnetic composite material comprises a resin matrix with magnetic particles. In some examples, the conductive core corresponds to a conductive material of a plated through-hole extending through the magnetic material. In some examples, the plated through-hole includes a conductive plug. In some examples, wherein the plated through-hole includes a dielectric plug.

In some examples, the inductor further includes at least one pad on a surface of the substrate and connected to the conductive core. In some examples, at least a portion of the at least one pad extends along a surface of the magnetic material. In some examples, the inductor further includes one or more pads embedded in the magnetic material along the conductive core.

In one implementation, a device (e.g., with a vertically integrated through-magnetic inductor) includes a die and an inductor vertically integrated with the die. The inductor includes a substrate on a different plane than that of the die and magnetic material at least partially embedded in the substrate. The inductor further includes a conductive core extending through the magnetic material such that the magnetic material at least partially surrounds the conductive core. In some examples, the magnetic material comprises a resin matrix with magnetic particles.

In some examples, the conductive core corresponds to a conductive material of a plated through-hole extending through the magnetic material. In some examples, the plated through-hole includes a conductive plug or a dielectric plug. In some examples, the inductor further includes at least one pad on a surface of the substrate for connecting the conductive core to the die. In some examples, the inductor further includes one or more pads embedded in the magnetic material along the conductive core. In some examples, the device further includes an integrated voltage regulator (IVR) vertically integrated with the die and configured to supply power to the die. In some examples, the IVR includes the inductor.

In one implementation, a method for fabricating a through-magnetic inductor includes opening a cavity in a substrate, forming a plated through-hole in a magnetic inlay as a conductive core for the magnetic inlay, adding the magnetic inlay with the conductive core into the cavity, and filling the cavity.

In some examples, forming the plated through-hole further includes (i) depositing and/or placing a magnetic material into the cavity of the substrate, (ii) drilling a through-hole into the magnetic material, (iii) plating the through-hole, and (iv) plugging the through-hole.

In some examples, depositing and/or placing the magnetic material into the cavity comprises placing a preformed magnetic inlay into the cavity. In some examples, the method further includes performing a cavity fill after depositing the magnetic material. In some examples, the method further includes depositing a seed layer before plating the through-hole. In some examples, plugging the through-hole comprises performing a plated through-hole plugging.

In some examples, forming the plated through-hole further includes (i) depositing a magnetic film (ii) drilling a through-hole in the magnetic film, and (iii) forming a conductive core in the through-hole, and adding the magnetic inlay further comprises (iv) cutting out the magnetic inlay from the magnetic film, the magnetic inlay including the conductive core, and (v) placing the magnetic inlay into the cavity of the substrate.

In some examples, forming the conductive core further includes (a) depositing a seed layer in the through-hole, (b) plating the through-hole, (c) plugging the through-hole, and (d) plating the plugged through-hole. In some examples, forming the conductive core further comprises etching the plated through-hole.

In some examples, adding the magnetic inlay further comprises (i) forming a magnetic film with a conductive core, (ii) cutting out the magnetic inlay from the magnetic film, the magnetic inlay including the conductive core, and (iii) placing the magnetic inlay into the cavity of the substrate.

In some examples, forming a magnetic film with a conductive core further comprises (a) separately depositing a plurality of thin magnetic films, for each of the plurality of thin magnetic films: (b) drilling a through-hole into the thin magnetic film, and (c) plugging the through-hole with a conductive material, and (d) stacking the plurality of thin magnetic films.

In some examples, plugging the through-hole with the conductive material further comprises depositing a seed layer, plating the through-hole to fill the through-hole, and etching the filled through-hole. In some examples, a thickness of the thin magnetic film allows filling the through-hole by plating the through-hole.

In some examples, adding the magnetic inlay into the cavity of the substrate further comprises (i) applying lamination tape to the substrate, (ii) placing the magnetic inlay into the cavity, (iii) performing a cavity fill, and (iv) removing the lamination tape.

Features from any of the implementations described herein can be used in combination with one another in accordance with the general principles described herein. These and other implementations, features, and advantages will be more fully understood upon reading the following detailed description in conjunction with the accompanying drawings and claims.

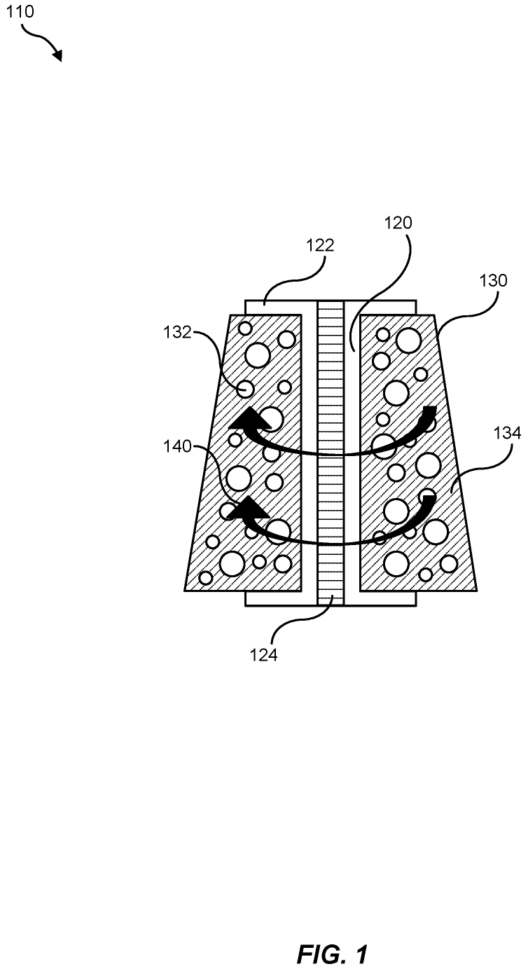

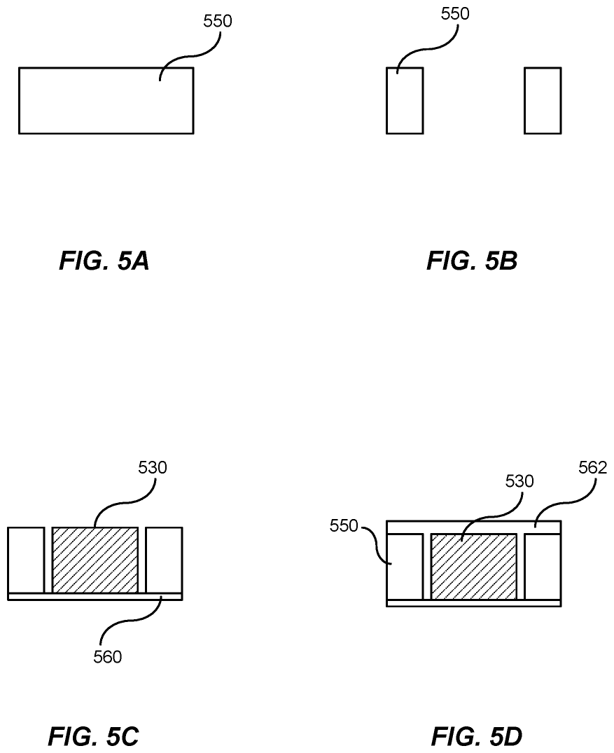

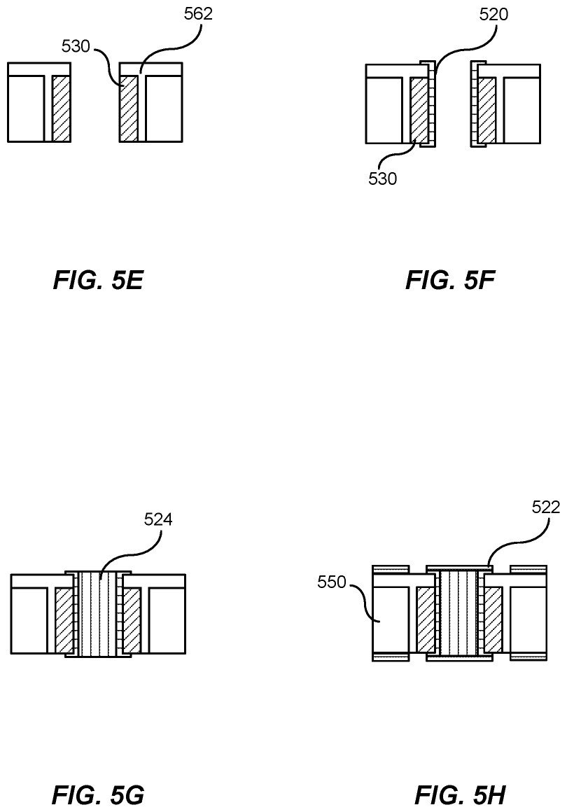

The following will provide, with reference to FIGS. 1-7H, detailed descriptions of through-magnetic inductors and fabrication thereof. Detailed descriptions of example through-magnetic inductors and systems incorporating through-magnetic inductors will be provided in connection with FIGS. 1-4. Detailed descriptions of corresponding fabrication methods and/or processes will also be provided in connection with FIGS. 5-8.

FIG. 1 illustrates an inductor 110 having a conductive core 120 and a magnetic material 130 at least partially surrounding conductive core 120. As illustrated in FIG. 1, magnetic material 130 can completely/fully surround conductive core 120 (e.g., along a full height of conductive core 120 and/or around all sides of conductive core 120), although in other examples magnetic material 130 can partially surround conductive core 120 (e.g., less than the full height of conductive core 120, having gaps therein, and/or not covering all sides of conductive core 120). A pad 122 is connected to conductive core 120 to allow for electrical connections to other components. When a current flows through conductive core 120, a magnetic flux 140 forms around conductive core 120, as indicated by the arrows in FIG. 1. As illustrated in FIG. 1, the magnetic flux path of magnetic flux 140 extends through magnetic material 130, increasing the inductance of inductor 110 as compared to if the magnetic flux path extended through a dielectric material such as air. As further illustrated in FIG. 1, magnetic material 130 can in some examples be made of a magnetic composite material, such as magnetic particles 132 (e.g., spherical or flake particles that can be ferrite, an iron-based alloy/metal, and/or another magnetic material) suspended in a preformed resin matrix 134 although in other examples magnetic material 130 can be made of any other magnetic or semi-magnetic material.

FIG. 1 illustrates a side cut-away view of a conductive core 120 that can correspond to a PTH (e.g., a hole drilled through a substrate, having its walls plated with a conductive material such as copper and is hollow or filled with a dielectric material). In some examples, conductive core 120 can be fabricated as a PTH due to fabrication process considerations, such as cost, availability of equipment, etc. In some examples, conductive core 120 can include a plug 124 that can be made of a dielectric material, or other material, such as a conductive material, a magnetic material, etc. However, a conductive core filled with conductive material (e.g., is a solid conductive core rather than filled with dielectric material, and/or filled with a different conductive material), can in some examples exhibit further improvements in inductive performance. In yet other examples, conductive core 120 can be hollow or partially filled.

Moreover, FIG. 1 illustrates example shapes for the various components (e.g., conductive core 120, pad 122, magnetic material 130). In other examples, these components can take on different shapes, dimensions, arrangements, etc. and further can be made of other appropriate materials.

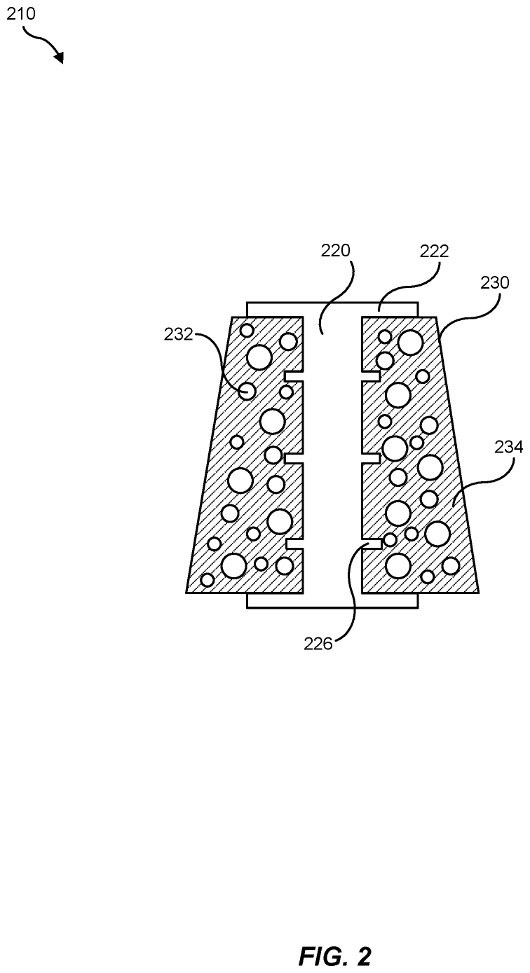

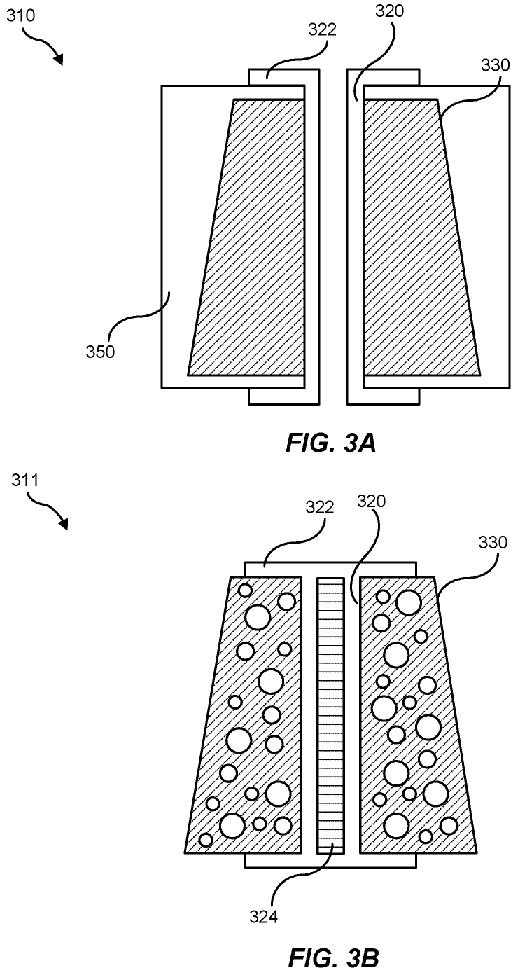

FIG. 2 illustrates a side cut-away view of a variation of a through-magnetic inductor, namely an inductor 210 corresponding to inductor 110. Similar to inductor 110, inductor 210 includes a conductive core 220 (corresponding to conductive core 120) that is connected to a pad 222 (corresponding to pad 122), and a magnetic material 230 (corresponding to magnetic material 130) surrounding conductive core 220. Similar to FIG. 1, magnetic material 230 can be made of a resin matrix 234 having magnetic particles 232 suspended therein, although in other examples magnetic material 230 can be made of any magnetic or semi-magnetic material. However, rather than being hollow or filled with dielectric material (as in FIG. 1), conductive core 220 can be filled with conductive material. For example, conductive core 220 can be a solid structure made of a conductive material (e.g., copper). In some examples, inductor 210 includes several pads 226 embedded in magnetic material 230 along conductive core 220, as illustrated in FIG. 2. Pads 226 can be residual structures left over from fabricating inductor 210 using standard fabrication processes, as will be described further below.

FIGS. 3A-3B illustrate side cut-away views of a variations of a through-magnetic inductor, namely an inductor 310 in FIG. 3A corresponding to inductor 110, and an inductor 311 in FIG. 3B corresponding to inductor 110. Similar to inductor 110, inductor 310 and inductor 311 each include a conductive core 320 (corresponding to conductive core 120) that is connected to a pad 322 (corresponding to pad 122), and a magnetic material 330 (corresponding to magnetic material 130) surrounding conductive core 320. Magnetic material 330 can be made of any magnetic or semi-magnetic material.

In FIG. 3A, conductive core 320 can be hollow. Further, in FIG. 3A, inductor 310 can be at least partially embedded in, for instance, a substrate 350 such that pad 322 can be exposed on surfaces of substrate 350. Although FIG. 3A illustrates inductor 310 partially embedded in substrate 350 (e.g., having portions that are embedded within substrate 350 and portions extending out of substrate 350), in other examples, inductor 310 can be completely/fully embedded in substrate 350 (e.g., having all portions within substrate 350 and/or under surfaces thereof). In FIG. 3B, conductive core 320 can be filled with a plug 324 (corresponding to plug 124) that can be filled with, for example, dielectric material, conductive material, magnetic material, etc. In addition, in FIG. 3B, pad 322 can cover plug 324. Although FIGS. 3A-3B illustrate additional examples of a through-magnetic inductor, in yet other examples, the through-magnetic inductor can include other variations and/or combinations of features as described herein.

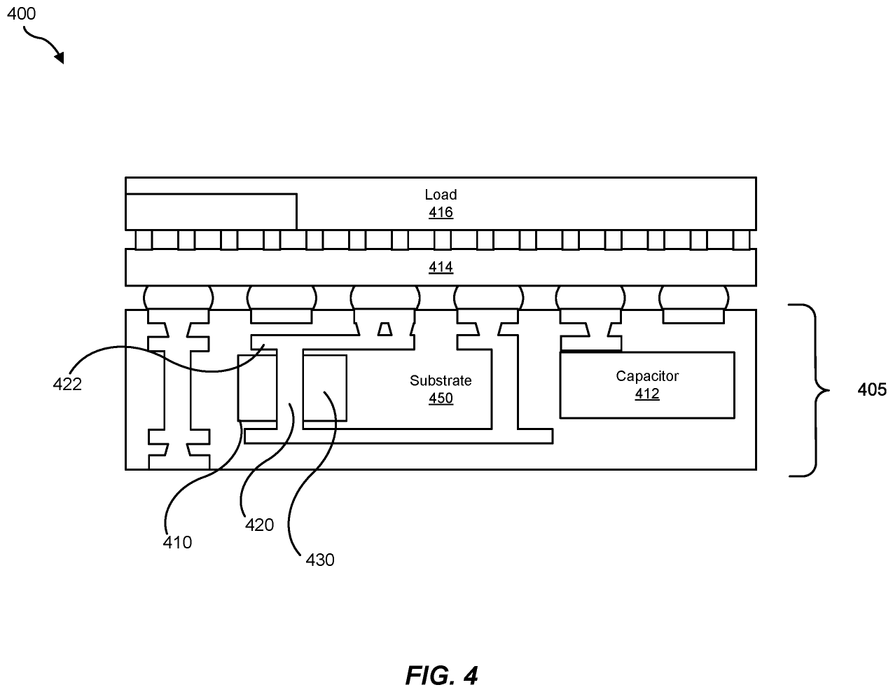

FIG. 4 illustrates an example device 400 having an integrated voltage regulator

(IVR) 405 in a substrate 450, and a load 416 vertically integrated with IVR 405 via an interposer 414. Load 416 can correspond to one or more dies (e.g., chips, chiplets, FETs, and/or other components) that IVR 405 supplies with power. IVR 405 includes components embedded in substrate 450, including an inductor 410 and a capacitor 412 along with various electrical connections (e.g., wires, pads, contacts, interconnects, etc.). As illustrated in FIG. 4, inductor 410 (e.g., IVR 405 and components therein) can be

Inductor 410 corresponds to inductor 110 and/or any other inductor described herein. As further illustrated in FIG. 4, Inductor 410 is embedded in substrate 450 that is on a different plane than a plane of load 416 (e.g., such that substrate 450 is not significantly coplanar with load 416). More specifically, inductor 410 includes a conductive core 420 surrounded by a magnetic material 430 that is embedded in substrate 450. Conductive core 420 is connected to a pad 422 (corresponding to pad 122) for connecting to load 416 (e.g., vertically through various interconnects as illustrate in FIG. 4). Although an inductor with magnetic material can be produced and attached on top of a substrate, certain device/component requirements can restrict such an arrangement. For instance, embedding inductor 410 in substrate 450 allows vertical integration, as in FIG. 4. As will be described further below, various available fabrication methods can be used to feasibly manufacture through-magnetic inductors embedded into a substrate.

FIGS. 5A-5H illustrate stages of an example process for fabricating a through-magnetic inductor embedded into a substrate. In FIG. 5A (e.g., core selection), a substrate 550 is prepared. For example, a suitable material (e.g., a dielectric material, insulative material, laminate material, composite-material, resin-impregnated glass-weave/laminate, and/or other structural material as needed) can be formed using an appropriate method (e.g., glass-weave impregnation, resin coating of fibers, chemical vapor deposition, physical vapor deposition, atomic-layer deposition, selective deposition, etc.) or other process for producing substrate 550. Substrate 550 can be an appropriate thickness as needed for a particular device/application. In FIG. 5B (e.g., cavity drill), a cavity is opened in substrate 550, for example by drilling, etching, etc. Dimensions and/or shape of the cavity can correspond to the dimensions and/or shape needed for embedding a component. For example, in some implementations substrate 550 can correspond to a core of a substrate (e.g., such that other portions of a device's substrate can include other materials/structures), although in other implementations, substrate 550 can correspond to the device's substrate.

FIGS. 5C-5G illustrate adding a magnetic inlay with a conductive core into the cavity. For example, in FIG. 5C (e.g., tape lamination and picking and placing), a lamination tape 560 is applied to substrate 550 (e.g., on a backside thereof). A magnetic inlay 530 is deposited into the cavity. In some examples, lamination tape 560 can hole substrate 550 and/or magnetic inlay 530 in place during this stage. Magnetic inlay 530 can be a preformed magnetic inlay, such as a magnetic or semi-magnetic material (e.g., a magnetic composite material as described herein) that in some examples has been separately deposited, formed, and cut (e.g., into appropriate dimensions) into magnetic inlay 530 for placing into the cavity. In other examples, magnetic inlay 530 can be deposited into the cavity using any appropriate deposition process.

In FIG. 5D (e.g., cavity fill), a cavity fill is performed after depositing the magnetic material. For example, a dielectric material 562 (e.g., a resin or an oxide), can fill the cavity, further filling in gaps between structures (e.g., between substrate 550 and magnetic inlay 530). In FIG. 5E (e.g., tape removal and TH drill), lamination tape 560 is removed for further processing. A through-hole is formed (e.g., via drilling, etching, etc.) magnetic inlay 530.

In FIG. 5F (e.g., seed layer deposit and plating and etching), a seed layer is deposited into the through-hole, which can facilitate a following plating step (e.g., adding conductive material to sidewalls of the through-hole) to form a conductive core 520. The plating can be etched, which can include removing excess material (e.g., via wet etching, plasma etching, etc.) and forming pads (e.g., via masking steps for desired patterns). As illustrated in FIG. 5F, a plated through-hole (PTH) is formed in magnetic inlay 530.

In FIG. 5G (e.g., PTH plugging), a PTH plugging is performed (e.g., filling the through-holes with dielectric material) to form a plug 524. In FIG. 5H (e.g., polishing, and final core plating), the surfaces are polished and cleaned. Additional plating for contacts/pads can performed, for example to produce a pad 522 as well as other contacts and structures as needed. Further build up processes can be performed, such that substrate 550 is finalized and additional processes for building components can be performed. Additional processing steps can also be performed at and/or between each of the stages described herein as needed. Moreover, although FIGS. 5A-5H depict a particular number of features (e.g., through-holes, structures, etc.)

in other examples, additional or fewer features can be fabricated, with steps repeated/modified and different materials used as needed.

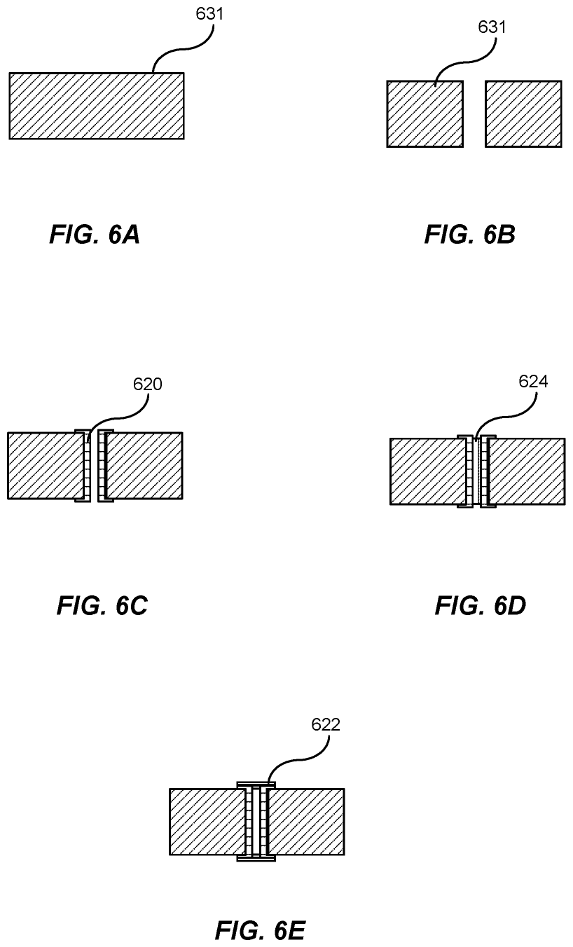

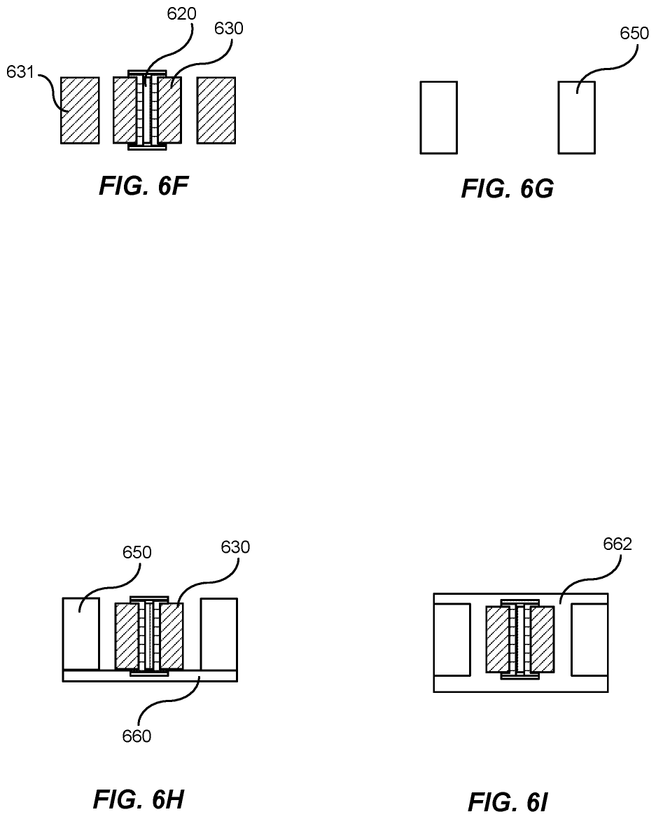

FIGS. 6A-6I illustrate stages of another example process for fabricating a through-magnetic inductor embedded into a substrate. In FIG. 6A (e.g., start with magnetic film), a magnetic film 631 is deposited or, in some examples, preformed. Magnetic film 631 can be a magnetic or semi-magnetic material (e.g., a magnetic composite material as described herein) deposited to an appropriate thickness for a particular device/application, which in some examples can correspond to a substrate thickness. In FIG. 6B (drill through-holes), a through-hole is formed (e.g., via drilling, mechanical drilling, laser drilling, etching, etc.) through magnetic film 631.

FIGS. 6C-6E illustrate forming a conductive core in the through-hole. In FIG. 6C (e.g., deposit seed layer and plate and etch), a seed layer is deposited in the through hole. The through-hole is plated to form a conductive core 620, and the PTH is etched as needed. In FIG. 6D (e.g., plug through-holes and polishing), the through-hole is plugged (e.g., via PTH plugging) to form a plug 624. The surfaces of magnetic film 631 can also be polished. In FIG. 6E (e.g., plating), the plugged PTH is plated and can further be etched as needed, for example to form a pad 622.

In FIG. 6F (e.g., cut out magnetic inlay), a magnetic inlay 630 (including conductive core 620) is cut out from magnetic film 631, for example using etching, sawing, etc. In FIG. 6G (e.g., cavity drill in substrate core), a cavity is opened in a substrate 650 (see, also FIGS. 5A-5B). Substrate 650 can have an appropriate thickness for a particular device/application, and magnetic inlay 630 can have a corresponding thickness. In FIG. 6H (e.g., tape lamination and pick and place), a lamination tape 660 is applied to substrate 650 (e.g., to a backside thereof), and magnetic inlay 630 is placed into the cavity of substrate 650. In FIG. 6I (e.g., cavity fill, tape remove, and build up), the cavity is filled with a dielectric material 662, and lamination tape 660 is removed.

Additional plating for contacts/pads can performed, as well as other contacts and structures as needed. Further build up processes can be performed, such that substrate 650 is finalized and additional processes for building components can be performed. Additional processing steps can also be performed at and/or between each of the stages described herein as needed. Moreover, although FIGS. 6A-6I depict a particular number of features (e.g., through-holes, structures, etc.) in other examples, additional or fewer features can be fabricated, with steps repeated/modified and different materials used as needed.

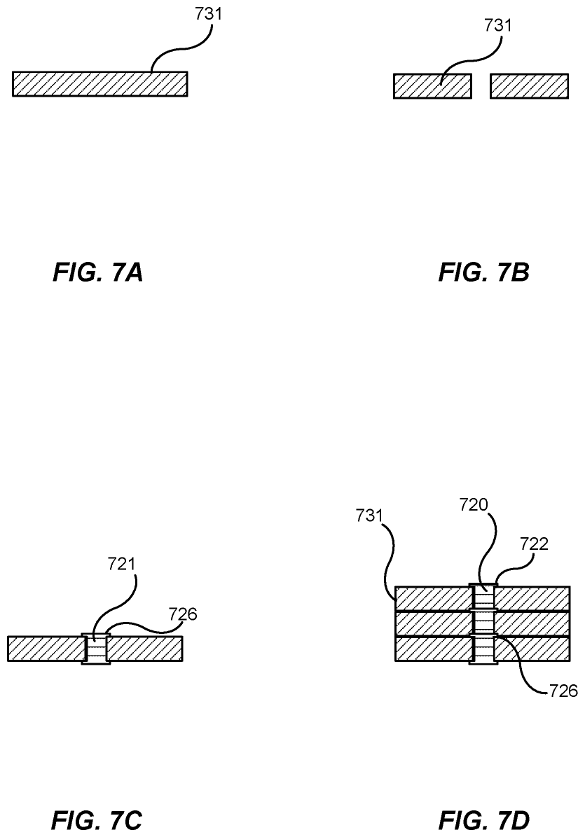

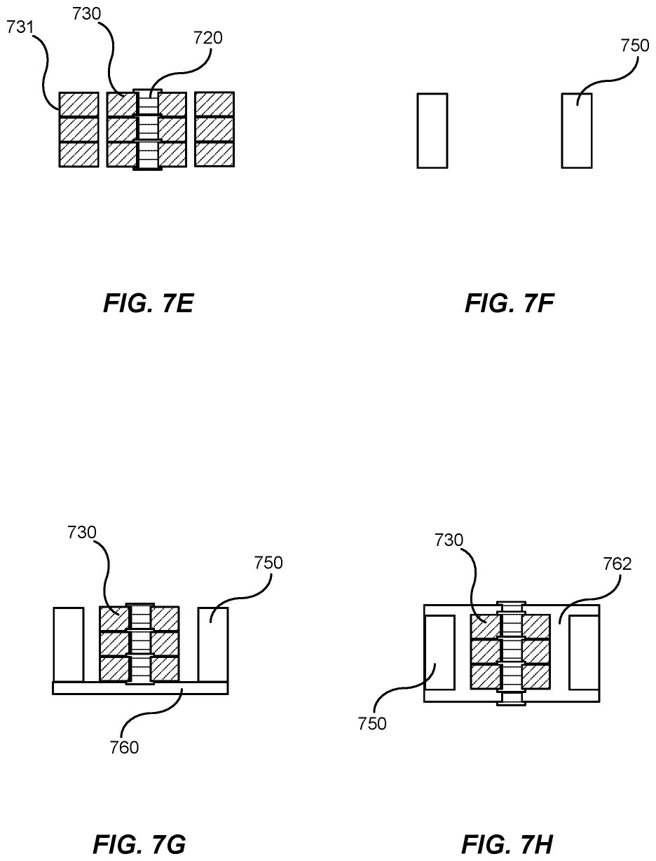

FIGS. 7A-7H illustrate stages of another example process for fabricating a through-magnetic inductor embedded into a substrate. FIGS. 7A-7E illustrate forming a magnetic film with a conductive core. In FIG. 7A (e.g., start with thin magnetic film), a thin magnetic film 731 is deposited. Thin magnetic film 731 can be made of a magnetic or semi-magnetic material (e.g., a magnetic composite material as described herein). A thickness of thin magnetic film 731 can be thin enough such that a through-hole in thin magnetic film 731 can be filled via plating, as further described herein. Moreover, a thickness of thin magnetic film 731 can be less than that of a corresponding substrate. In FIG. 7B (e.g., drill through-holes), a through-hole is formed (e.g., via drilling, etching, etc.) into thin magnetic film 731. In FIG. 7C (e.g., deposit seed layer and plate and etch), a seed layer is deposited into the through-hole. The through-hole is plated and subsequently etched as needed. As illustrated in FIG. 7C, the plating can fill or plug the through-hole with conductive material to form a conductive plug 721 having a pad 726.

In FIG. 7D (e.g., repeating and stack layers), multiple thin magnetic films 731 can be formed separately (e.g., repeating the steps described with respect to FIGS. 7A-7C) and then stacked. A number of thin magnetic films 731 formed and stacked can be based on a desired final height of a magnetic inlay. For example, FIG. 7D illustrates stacking three thin magnetic films 731 to form a structure having a thickness or height corresponding to that of a substrate, although in other examples a different number can be used. By forming multiple thin magnetic films 731 having respective conductive plugs 721 and stacking the thin magnetic films 731, a solid conductive core 720 (having a pad 722) can be fabricated having a desired thickness without requiring processes outside of a normal fabrication workflow. In some examples, pads 726 can remain as residual structures (see also FIG. 2). Further, in some examples, thin magnetic films 731 and conductive plugs 721 can be produced in different configurations as needed. For instance, FIG. 7D illustrates conductive plugs 721 as aligned when stacked, although in other examples other stacking arrangements (e.g., staggered, alternating offsets, etc.) and/or other intermediary structures/layers can be used.

In FIG. 7E (e.g., cut out magnetic inlay), a magnetic inlay 730 (including conductive core 720) is cut out (e.g., via sawing, etching, etc.) from the stacked thin magnetic films 731. In FIG. 7E (e.g., cavity drill in substrate core), a cavity is opened in a substrate 750 similar to descriptions provided herein. A thickness of substrate 750 can correspond to a desired thickness for a particular device/application and can further correspond to a thickness of magnetic inlay 730. In FIG. 7G (tape lamination and pick and place), a lamination tape 760 is applied to substrate 750 (e.g., to a backside thereof) and magnetic inlay 730 is placed into the cavity of substrate 750.

In FIG. 7H (e.g., cavity fill, tape remove, and further build up as needed), a cavity fill is performed by filling the cavity with a dielectric material 762. Lamination tape 760 is removed. Additional plating for contacts/pads can performed, as well as other contacts and structures as needed. Further build up processes can be performed, such that substrate 750 is finalized and additional processes for building components can be performed. Additional processing steps can also be performed at and/or between each of the stages described herein as needed. Moreover, although FIGS. 7A-7H depict a particular number of features (e.g., through-holes, structures, etc.) in other examples, additional or fewer features can be fabricated, with steps repeated/modified and different materials used as needed.

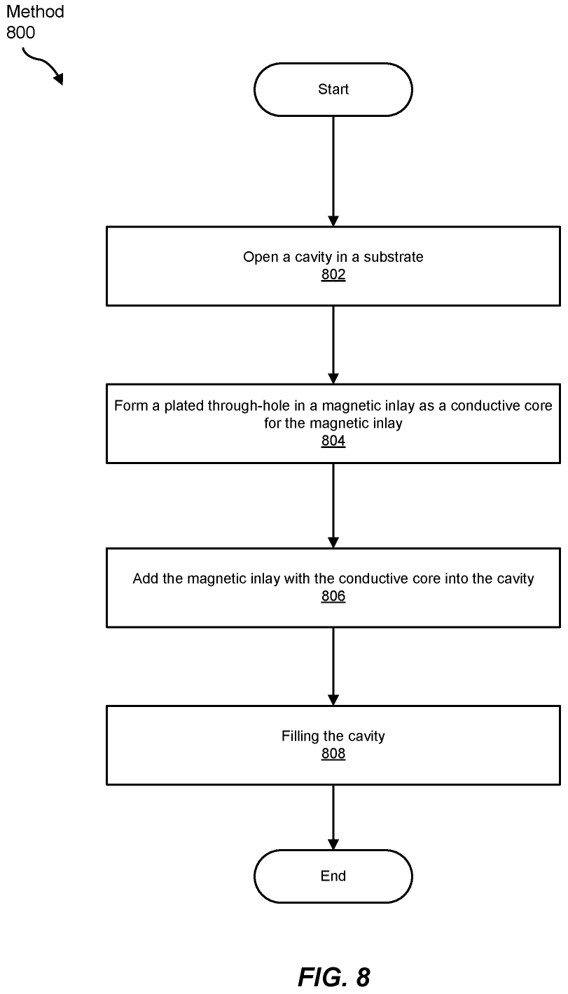

FIG. 8 is a flow diagram of an exemplary method 800 for fabricating a through-magnetic inductor that is embedded in a substrate. The steps shown in FIG. 8 can be performed by any suitable fabrication method and/or process. In one example, each of the steps shown in FIG. 8 represent an algorithm whose structure includes and/or is represented by multiple sub- steps, examples of which will be provided in greater detail below.

As illustrated in FIG. 8, at step 802 one or more of the systems described herein open a cavity in a substrate. For example, a cavity can be opened in substrate 550 in FIG. 5B (see also, substrate 650 in FIG. 6G and substrate 750 in FIG. 7F).

At step 804 one or more of the systems described herein form a plated through-hole in a magnetic inlay as a conductive core for the magnetic inlay. At step 806 one or more of the systems described herein add a magnetic inlay with a conductive core into the cavity. The systems described herein can perform steps 804 and/or 806 in a variety of ways, which in some implementations can be combined and/or integrated as part of a process (e.g., of forming the magnetic inlay having a conductive core) and in other implementations can be separate discrete steps.

In some examples, adding the magnetic inlay further includes depositing and/or placing a magnetic material into the cavity of the substrate (see, e.g., FIG. 5C), drilling a through-hole into the magnetic material (see, e.g., FIG. 5E), plating the through-hole (see, e.g., FIG. 5F), and plugging the through-hole (see, e.g., FIG. 5G).

In some examples, method 800 further includes performing a cavity fill after depositing the magnetic material (see, e.g., FIG. 5D, and also FIGS. 6I and 7H). In some examples, method 800 further includes depositing a seed layer before plating the through-hole. Further, plugging the through-hole includes, in some examples, performing a plated through-hole plugging (see, e.g., FIG. 5G and also FIG. 6D).

In some examples, adding the magnetic inlay into the cavity includes placing a preformed magnetic inlay into the cavity (see, e.g., FIGS. 6H and 7G). More specifically, in some examples, adding the magnetic inlay (e.g., placing the preformed magnetic inlay) includes depositing a magnetic film (see FIG. 6A), drilling a through-hole in the magnetic film (see FIG. 6B), forming a conductive core in the through-hole (see FIG. 6C), cutting out the magnetic inlay that includes the conductive core from the magnetic film (see FIG. 6F), and placing the magnetic inlay into the cavity of the substrate (see FIG. 6H).

In some examples, forming the conductive core further includes depositing a seed layer in the through-hole and plating the through-hole (see FIG. 6C), plugging the through-hole (see FIG. 6D), and plating the plugged through-hole (see FIG. 6E).

In some examples, forming the conductive core further includes etching the plated through-hole (see, e.g., FIGS. 6E, 5G, and 7C).

In some examples, adding the magnetic inlay (e.g., placing the preformed magnetic inlay) further includes forming a magnetic film with a conductive core (see FIGS. 7A-7D), cutting out the magnetic inlay that includes the conductive core from the magnetic film (see FIG. 7E), and placing the magnetic inlay into the cavity of the substrate (see FIG. 7G).

In some examples, forming a magnetic film with a conductive core further includes separately depositing a plurality of thin magnetic films (see FIG. 7A, for each of the plurality of thin magnetic films drilling a through-hole into the thin magnetic film (see FIG. 7B), and plugging the through-hole with a conductive material (see FIG. 7C), and stacking the plurality of thin magnetic films (see FIG. 7D).

In some examples, plugging the through-hole with the conductive material further includes depositing a seed layer, plating the through-hole to fill the through-hole, and etching the filled through-hole (see FIG. 7C). In some examples, a thickness of the thin magnetic film allows filling the through-hole by plating the through-hole.

In some examples, placing the magnetic inlay into the cavity of the substrate further includes applying lamination tape to the substrate (see, e.g., FIGS. 6H, 7G), placing the magnetic inlay into the cavity (see, e.g., FIGS. 6I, 7H), performing a cavity fill (see, e.g., FIGS. 6I, 7H), and removing the lamination tape (see, e.g., FIGS. 6I, 7H).

Returning to FIG. 8, at step 808 one or more of the systems described herein fill the cavity. For example, plugging the through-hole or performing a cavity fill (e.g., as described above, which can be performed as part of step 806) can be performed. Moreover, plating, etching, polishing, and other build up processes that can include adding additional layers for finalizing the substrate as described herein.

Moreover, although examples of inductors are described herein, in other implementations, the steps of method 800 can be modified as needed to produce other embedded components that utilize magnetic materials and/or conductive cores.

As detailed above, air-core Inductors (ACIs) using substrate-defined copper lines and plated-through holes (PTHs) are often used for their inductance as part of a power distribution network (PDN), particularly in integrated-voltage regulation (IVR) solutions where power conversion is performed at the package-level. For example, a single-turn ACI structure makes use of standard substrate processes. Replacing dielectric material with high-permeability magnetic material means higher inductance for the same copper structure. This can benefit IVR performance by providing better power delivery and efficiency. By forming a PTH directly through the magnetic inlay, the inductance gain can be much larger with low-reluctance flux lines traversing solely through the magnetic inlay. By using a magnetic prepreg consisting of an organic matrix and magnetic fillers, it can be possible to plate copper directly, although the through-hole could first be filled with dielectric before being re-drilled if needed.

Unlike a discrete magnetic inductor, the through-magnetic PTH (TMPTH) inductor described herein can be integrated directly into the substrate, making use of embedded component processing. Instead of forming discrete inductor arrays, a magnetic prepreg inlay is first embedded into a substrate cavity before cavity filling, similar to passive component or integrated passive device (IPD) embedding. The PTH can then be formed directly through the magnetic material for a large inductance that is proportional to the thickness of the core (or height of the PTH). While discrete IVR inductors can rely on through-magnetic copper lines for the majority of their inductance, the implementations disclosed herein makes use of through-magnetic PTH for the primary source of inductance.

Unlike coaxial inductor PTHs based on magnetic paste, the systems and methods described herein do not rely on a paste-filling process to surround the PTH with magnetic material, but instead magnetic prepregs or magnetic composites that are embedded into the core prior to PTH formation or with already-included vertical copper structures

The magnetic material surrounding the inductor PTH(s) can provide a large increase in inductance compared to an ACI. PTHs generally provide lower per-unit-length resistance compared to Cu lines, which improves the Q-factor, since PTH is the primary copper structure forming the inductors described herein. Integration of the inductors directly into the substrate core also avoids using additional real-estate in a surface-mount technology (SMT) approach, as well as avoiding the process steps needed for SMT (e.g., plating of discrete component and additional reflow). An advantage of the inductor structure described herein is that the inductor structure is not limited to the ball grid array (BGA) collapse height as it might be in an SMT approach, but instead limited by the substrate core thickness (which is generally much larger for large SoC, high-power applications). Thus, the benefits from adding magnetics can be more properly utilized. The size of the magnetic inlay, as well as the density of PTH going through it, can be tuned to meet the application requirements (in terms of inductance, coupling between phases, area usage, saturation current, and temperature rise).

Moreover, compared to a coaxial magnetic paste-PTH, the systems and methods described herein can, in some implementations, avoid using a paste-filling process to form the magnetic matrix surrounding the Cu PTHs. There can be contamination concerns when using a paste-filling process, as well as being restricted to using spherical magnetic filler particles. When using a prepreg or similar magnetic-composite material or film, selectively oriented magnetic flakes can be utilized, which can be designed so that primarily the hard axes of the magnetic dipoles are excited. Magnetic hard axes generally have higher magnetization and lower loss before flux saturation, which results in higher current handling at the device level. Magnetic composite films also generally can include a higher volume-percent of magnetic material compared to paste materials that require viscous flow during the integration process.

As detailed above, the computing devices and systems described and/or illustrated herein broadly represent any type or form of computing device, graphics processing device, integrated circuit, or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs),digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An inductor comprising:
a substrate;
a magnetic material at least partially embedded in the substrate; and
a conductive core extending at least partially through the magnetic material such that the magnetic material at least partially surrounds the conductive core.

2. The inductor of claim 1, wherein the magnetic material comprises a magnetic composite material.

3. The inductor of claim 2, wherein the magnetic composite material comprises a resin matrix with magnetic particles.

4. The inductor of claim 1, wherein the conductive core corresponds to a conductive material of a plated through-hole extending through the magnetic material.

5. The inductor of claim 4, wherein the plated through-hole includes a conductive plug.

6. The inductor of claim 4, wherein the plated through-hole includes a dielectric plug.

7. The inductor of claim 1, further comprising at least one pad on a surface of the substrate and connected to the conductive core.

8. The inductor of claim 7, wherein at least a portion of the at least one pad extends along a surface of the magnetic material.

9. The inductor of claim 1, further comprising one or more pads embedded in the magnetic material along the conductive core.

10. A device comprising:
a die; and
an inductor vertically integrated with the die and comprising:
a substrate on a different plane than that of the die;
a magnetic material at least partially embedded in the substrate; and
a conductive core extending through the magnetic material such that the magnetic material at least partially surrounds the conductive core.

11. The device of claim 10, wherein the conductive core corresponds to a conductive material of a plated through-hole extending through the magnetic material.

12. The device of claim 11, wherein the plated through-hole includes a conductive plug or a dielectric plug.

13. The device of claim 10, wherein the inductor further comprises at least one pad on a surface of the substrate for connecting the conductive core to the die.

14. The device of claim 10, wherein the inductor further comprises one or more pads embedded in the magnetic material along the conductive core.

15. The device of claim 10, further comprising an integrated voltage regulator (IVR) vertically integrated with the die and configured to supply power to the die, wherein the IVR includes the inductor.

16. A method comprising:
opening a cavity in a substrate;
forming a plated through-hole in a magnetic inlay as a conductive core for the magnetic inlay;
adding the magnetic inlay with the conductive core into the cavity; and
filling the cavity.

17. The method of claim 16, wherein forming the plated through-hole further comprises:
placing a magnetic material into the cavity of the substrate;
drilling a through-hole into the magnetic material;
plating the through-hole; and
plugging the through-hole.

18. The method of claim 16, wherein:
forming the plated through-hole further comprises:
depositing a magnetic film;
drilling a through-hole in the magnetic film; and
forming a conductive core in the through-hole; and
adding the magnetic inlay further comprises:
cutting out the magnetic inlay from the magnetic film, the magnetic inlay including the conductive core; and
placing the magnetic inlay into the cavity of the substrate.

19. The method of claim 16, wherein adding the magnetic inlay further comprises:
forming a magnetic film with a conductive core;
cutting out the magnetic inlay from the magnetic film, the magnetic inlay including the conductive core; and
placing the magnetic inlay into the cavity of the substrate.

20. The method of claim 19, wherein forming a magnetic film with a conductive core further comprises:
separately depositing a plurality of thin magnetic films;
for each of the plurality of thin magnetic films:
drilling a through-hole into the thin magnetic film; and
plugging the through-hole with a conductive material; and
stacking the plurality of thin magnetic films.
